(19) United States
(12) Patent Application Publication
(10) Pub. No.: US 2010/0187483 A1
(43) Pub. Date: Jul. 29, 2010

(54) VOLTAGE SWITCHABLE DIELECTRIC COMPOSITION USING BINDER WITH ENHANCED ELECTRON MOBILITY AT HIGH ELECTRIC FIELDS

(76) Inventors: Robert Fleming, San Jose, CA (US); Ning Shi, San Jose, CA (US); Pragnya Saraf, San Jose, CA (US)

Correspondence Address: MAHAMEDI PARADICE KREISMAN LLP, 550 Winchester Boulevard, Suite 605, SAN JOSE, CA, 95128, US

(21) Appl. No.: 12/692,573

(22) Filed: Jan. 22, 2010

Related U.S. Application Data
(60) Provisional application No. 61/147,055, filed on Jan. 23, 2009.

(51) Int. Cl. H01B 1/22; H01B 1/00; H01B 1/24; H01B 1/20

(52) U.S. Cl. 252/506; 252/500; 252/512; 252/511; 252/520.1; 252/519.5; 252/518.1; 977/742; 977/773

(57) ABSTRACT

A binder for VSD composition is selected to have enhanced electron mobility in presence of high electric fields.

### RELATED APPLICATIONS

This application claims benefit of priority to Provisional U.S. Patent Application No. 61/147,055; the aforementioned priority application being hereby incorporated by reference in its entirety.

This application also claims benefit of priority to U.S. patent application Ser. No. 11/829,946; which claims benefit of priority to Provisional U.S. Patent Application No. 60/820,786; Provisional U.S. Patent Application No. 60/826,746; and Provisional U.S. Patent Application No. 60/949,179; all of the aforementioned priority applications being hereby incorporated by reference.

This application also claims benefit of priority to U.S. patent application Ser. No. 11/829,948; which claims benefit of priority to Provisional U.S. Patent Application No. 60/820,786; Provisional U.S. Patent Application No. 60/826,746; and Provisional U.S. Patent Application No. 60/949,179; all of the aforementioned priority applications being hereby incorporated by reference.

### TECHNICAL FIELD

Embodiments described herein pertain generally to voltage switchable dielectric (VSD) material, and more specifically to VSD material that uses a binder with enhanced electron mobility at high electric fields.

### BACKGROUND

Voltage switchable dielectric (VSD) materials are materials that are insulative at low voltages and conductive at higher voltages. These materials are typically composites comprising of conductive, semiconductive, and insulative particles in a polymer matrix. These materials are used for transient protection of electronic devices, most notably electrostatic discharge protection (ESD) and electrical overstress (EOS). Generally, VSD material behaves as a dielectric, unless a characteristic voltage or voltage range is applied, in which case it behaves as a conductor. Various kinds of VSD material exist. Examples of voltage switchable dielectric materials are provided in references such as U.S. Pat. No. 4,977,357, U.S. Pat. No. 5,068,634, U.S. Pat. No. 5,099,380, U.S. Pat. No. 5,142,263, U.S. Pat. No. 5,189,387, U.S. Pat. No. 5,248,517, U.S. Pat. No. 5,807,509, WO 96/02924, and WO 97/26665.

VSD materials may be formed in using various processes. One conventional technique provides that a layer of polymer is filled with high levels of metal particles to very near the percolation threshold, typically more than 25% by volume. Semiconductor and/or insulator materials is then added to the mixture.

Another conventional technique provides for forming VSD material by mixing doped metal oxide powders, then sintering the powders to make particles with grain boundaries, and then adding the particles to a polymer matrix to above the percolation threshold.

Other techniques for forming VSD material are described in U.S. patent application Ser. No. 11/829,946, entitled VOLTAGE SWITCHABLE DIELECTRIC MATERIAL HAVING CONDUCTIVE OR SEMI-CONDUCTIVE ORGANIC MATERIAL; and U.S. patent application Ser. No. 11/829,948, entitled VOLTAGE SWITCHABLE DIELECTRIC MATERIAL HAVING HIGH ASPECT RATIO PARTICLES.

### BRIEF DESCRIPTION OF THE DRAWINGS

FIG. 1 is an illustrative (not to scale) sectional view of a layer or thickness of VSD material, depicting the constituents of VSD material in accordance with various embodiments.

FIG. 2A and FIG. 2B depict conductivity versus electric field for epoxy (Epon) based polymer binders used in compositions of VSD material, as a basis of comparison for binder compositions that enhance electron mobility in presence of high electric fields.

FIG. 3A illustrates the conductivity versus electric field measurements for a HFC polymer, under an embodiment.

FIG. 3B and FIG. 3C depict conductivity versus electric field measurements for suitable alternative polymer materials that exhibit improved electron mobility at high electric fields, according to additional embodiments or variations.

FIG. 4 illustrates conductivity versus electric field measurements for a polymer-based matrix that includes various fillers, according to various embodiments.

FIG. 5A illustrates a substrate device that is configured with VSD material having a composition such as described with any of the embodiments provided herein.

FIG. 5B illustrates a configuration in which a conductive layer is embedded in a substrate.

FIG. 5C illustrates a vertical switching arrangement for incorporating VSD material into a substrate.

FIG. 6 is a simplified diagram of an electronic device on which VSD material in accordance with embodiments described herein may be provided.

### DETAILED DESCRIPTION

According to various embodiments, a binder for VSD composition is selected to have enhanced electron mobility in presence of high electric fields (such as resulting from an applied voltage measuring hundreds or thousands of volts). In some embodiments, polymer binder material is selected for exhibiting the characteristic of having greater electron mobility when high electric fields are present. As an addition or variation, some embodiments provide that the polymer binder is enhanced with semiconductive fillers to form a binder with improved electron mobility when high electric field is present.

According to embodiments, the binder or matrix for VSD material is formed from polymer material that has the characteristic of exhibiting relatively high electron mobility or conductivity when a high field is present. Such polymer materials are alternatively referenced as high field conductive (“HFC”) polymers. The HFC polymer matrix or binder enable VSD material to be formulated that has improved electrical characteristics, including reduced clamp and trigger voltages, as compared to non-conductive polymers typically used in VSD compositions (e.g. Epon 828).

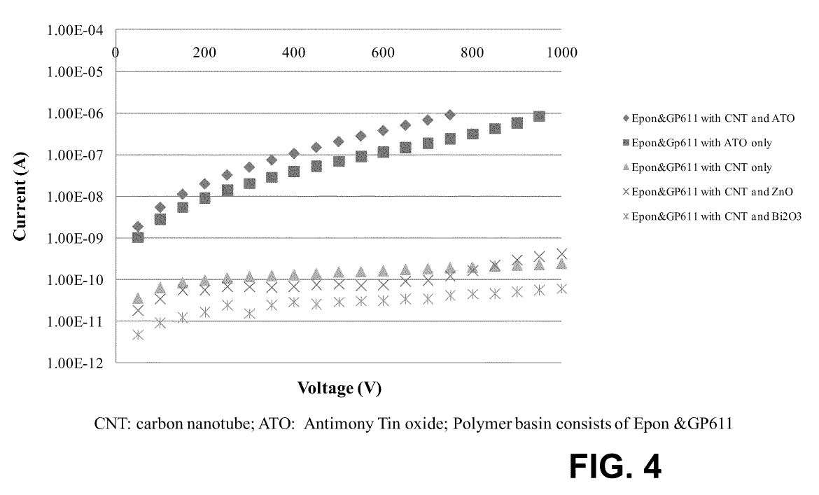

Additionally, according to some embodiments, a composition of VSD material includes a polymer matrix with fillers that are thoroughly mixed into a polymer resin to form a binder for VSD material. As described with an embodiment of FIG. 4, the presence of fillers enhances the overall electron mobility of the VSD material, so as to reduce clamp and trigger voltages of VSD compositions formed from the binder. Additional particles, such as conductive material (e.g. metal particles) can be added to the binder. The total particle concentration of the resulting VSD material may be below the percolation threshold.

With regard to polymer composition in VSD material, it is believed that when a sufficiently high electric field is present (e.g. one that surpasses a characteristic threshold) an internal field between conductive particles becomes high enough to conduct electrons from one conductive particle through the polymer to the next conductive polymers. As mentioned elsewhere, the internal field for VSD material can be of an order of magnitude or more greater than the applied field to the VSD material, as the result the applied external field is amplified by the conductive particles in the VSD composition. In VSD material, the polymer (or binder) acts as a “semiconductor” with an effective “bandgap”. Embodiments recognize that polymers for use as binder can be selected based on the assumption that if the high field electron mobility of the polymer matrix increases, the characteristic “turn on” voltage would decrease. In other words, if the polymer binder is selected or designed to have high field electron mobility, the corresponding composition of VSD material can be anticipated to have relatively lower trigger and clamp thresholds.

Embodiments further recognize that traditional undoped “conductive polymers” are not necessarily in the category of polymers that can be considered to have high field conductivity. In fact, undoped polymers that, under conventional considerations, are considered to be conductive polymers, do not necessarily conduct under high fields more than other polymers such as epoxy (e.g. Epon). Moreover, conventional conductive polymers typically ‘conduct’ (i.e. have lower resistance than other polymers) at low fields and therefore do not promote a characteristic “off-state” which is requisite for use in the composition of VSD. HFC polymers, on the other hand, are relatively non-conductive at low voltages and are considered ‘conductive’ with application of a relatively high field. It should be appreciated that the term ‘conductive’, in the context of describing the electrical resistance characteristic of a polymer, is a relative term that is specific to polymers as a class of material. A ‘conductive polymer’ is a non-conductive material, but conductive relative to polymers as a class.

According to an embodiment, an HFC polymer has the following characteristics: such polymer can carry at least one nano-amp of current in presence of a field that is equivalent to or exceeds 400 volts per mil. For reference, some examples are presented with accompanying figures that present current versus field values when voltage is applied across a 2.5 mil gap. While some embodiments described herein incorporate an HFC polymer, other embodiments incorporate polymer material that has enhanced electron mobility at high field. Thus, embodiments recognize that even modest improvements to the binder's high field electron mobility can have benefit to the resulting electrical properties of the VSD material.

Overview of VSD Material

As used herein, “voltage switchable material” or “VSD material” is any composition, or combination of compositions, that has a characteristic of being dielectric or non-conductive, unless a field or voltage is applied to the material that exceeds a characteristic level of the material, in which case the material becomes conductive. Thus, VSD material is a dielectric unless voltage (or field) exceeding the characteristic level (e.g. such as provided by ESD events) is applied to the material, in which case the VSD material is switched into a conductive state. VSD material can further be characterized as a nonlinear resistance material. With an embodiment such as described, the characteristic voltage may range in values that exceed the operational voltage levels of the circuit or device several times over. Such voltage levels may be of the order of transient conditions, such as produced by electrostatic discharge, although embodiments may include use of planned electrical events. Furthermore, one or more embodiments provide that in the absence of the voltage exceeding the characteristic voltage, the material behaves similar to the binder.

Still further, an embodiment provides that VSD material may be characterized as material comprising a binder mixed in part with conductor or semi-conductor particles. In the absence of voltage exceeding a characteristic voltage level, the material as a whole adapts the dielectric characteristic of the binder. With application of voltage exceeding the characteristic level, the material as a whole adapts conductive characteristics.

Many compositions of VSD material provide desired ‘voltage switchable’ electrical characteristics by dispersing a quantity of conductive materials in a polymer matrix to just below the percolation threshold, where the percolation threshold is defined statistically as the threshold by which a conduction path is likely formed across a thickness of the material. Other materials, such as insulators or semiconductors, are dispersed in the matrix to better control the percolation threshold. Still further, other compositions of VSD material, including some that include particle constituents such as core shell particles or other particles may load the particle constituency above the percolation threshold.

As described with some embodiments, the VSD material may be situated on an electrical device in order to protect a circuit or electrical component of device (or specific sub-region of the device) from electrical events, such as ESD or EOS. Accordingly, one or more embodiments provide that VSD material has a characteristic voltage level that exceeds that of an operating circuit or component of the device.

According to embodiments described herein, the constituents of VSD material may be uniformly mixed into a binder or polymer matrix. In one embodiment, the mixture is dispersed at nanoscale, meaning the particles that comprise the organic conductive/semi-conductive material are nano-scale in at least one dimension (e.g. cross-section) and a substantial number of the particles that comprise the overall dispersed quantity in the volume are individually separated (so as to not be agglomerated or compacted together).

Still further, an electronic device may be provided with VSD material in accordance with any of the embodiments described herein. Such electrical devices may include substrate devices, such as printed circuit boards, semiconductor packages, discrete devices, Light Emitting Diodes (LEDs), and radio-frequency (RF) components.

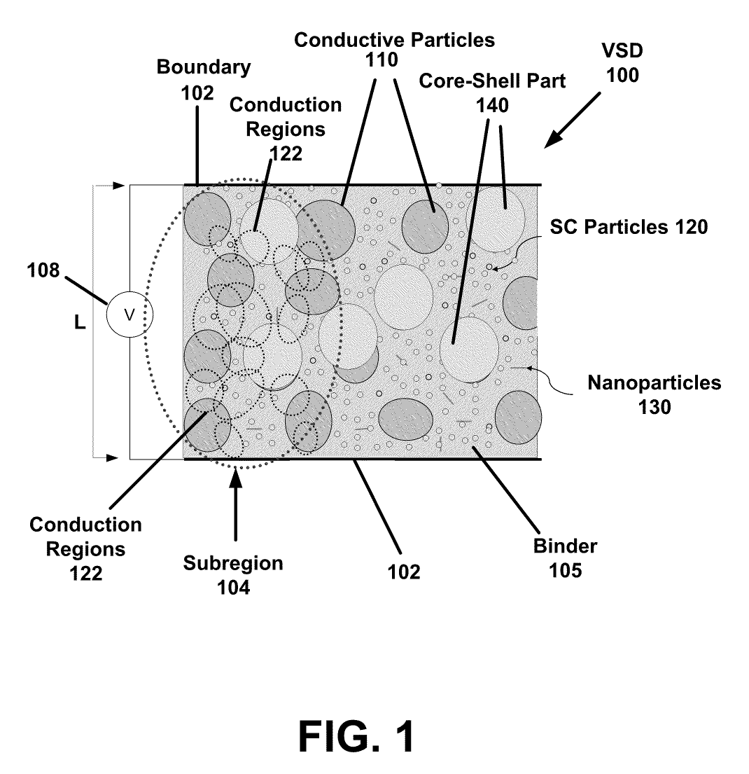

FIG. 1 is an illustrative (not to scale) sectional view of a layer or thickness of VSD material, depicting the constituents of VSD material in accordance with various embodiments. As depicted, VSD material 100 includes binder 105 and various types of particle constituents, dispersed in the binder in various concentrations. The particle constituents of the VSD material may include a combination of conductive particles 110, semiconductor particles 120, nano-dimensioned particles 130 and/or other particles 140 (e.g. core shell particles or varistor particles).

In some embodiments, the VSD composition omits the use of conductive particles 110, semiconductive particles 120, or nano-dimensioned particles 130. For example, the particle constituency of the VSD material may omit semiconductive particles 120. Thus, the type of particle constituent that are included in the VSD composition may vary, depending on the desired electrical and physical characteristics of the VSD material.

According to embodiments described herein, the matrix binder 105 is formulated from polymer material that has enhanced electron mobility at high electric fields. In some embodiments, the polymer material used for binder 105 includes HFC polymers, such as a polyacrylate (e.g. Hexanedioldiacrylate). As an addition or alternative, the polymer material includes blends or mixtures of polymers (monomers) with high electron mobility with polymers (monomers) with low electron mobility. Such polymers (or blends) with enhanced electron mobility are capable of carrying 1. 0E-9 current at approximately 400 volts per mil (extrapolated from empirical data at 1000 volts and across 2.5 mil gap). According to variations, the polymer binder 105 may also include mixtures of standard polymers (e.g. Epon or GP611) with HFC polymers or polymers with enhanced electron mobility under high field, the polymer binder 105 may be enhanced with use of nano-dimensioned particles 130, which are mixed into the binder to form a doped variant of the binder 105.

Examples of conductive materials 110 include metals such as copper, aluminum, nickel, silver, gold, titanium, stainless steel, nickel phosphorus, niobium, tungsten, chrome, other metal alloys, or conductive ceramics like titanium diboride or titanium nitride. Examples of semiconductive material 120 include both organic and inorganic semiconductors. Some inorganic semiconductors include silicon carbide, Boron-nitride, aluminum nitride, nickel oxide, zinc oxide, zinc sulfide, bismuth oxide, titanium dioxide, cerium oxide, bismuth oxide, in oxide, indium in oxide, antimony in oxide, and iron oxide, praseodynium oxide. The specific formulation and composition may be selected for mechanical and electrical properties that best suit the particular application of the VSD material.

The nano-dimensioned particles 130 may be of one or more types. Depending on the implementation, at least one constituent that comprises a portion of the nano-dimensioned particles 130 are (i) organic particles (e.g. carbon nanotubes (CNT), graphenes, C60 fullerenes); or (ii) inorganic particles (metallic, metal oxide, nanorods, or nanowires). The nano-dimensioned particles may have high-aspect ratios (HAR), so as to have aspect ratios that exceed at least 10:1 (and may exceed 1000:1 or more). Specific examples of such particles include copper, nickel, gold, silver, cobalt, zinc oxide, in oxide, silicon carbide, gallium arsenide, aluminum oxide, aluminum nitride, titanium dioxide, antimony, Boron-nitride, antimony in oxide, indium in oxide, indium zinc oxide, bismuth oxide, cerium oxide, and antimony zinc oxide. In at least some embodiments, the nano-dimensioned particles correspond to semiconductive fillers that form part of the binder. Such fillers can be uniformly dispersed in the polymer matrix or binder at various concentrations. As mentioned with an embodiment of FIG. 4, some of the nano-dimensioned particles (e.g. Antimony in oxide (ATO), CNT, zinc oxide, bismuth oxide (Bi₂O₃)) enhance the electron mobility of the binder 105 at high electric fields.

The dispersion of the various classes of particles in the matrix 105 is such that the VSD material 100 is non-layered and uniform in its composition, while exhibiting electrical characteristics of voltage switchable dielectric material. Generally, the characteristic voltage of VSD material is measured at volts/length (e.g. per 5 mil), although other field measurements may be used as an alternative to voltage. Accordingly, a voltage 108 applied across the boundaries 102 of the VSD material layer may switch the VSD material 100 into a conductive state if the voltage exceeds the characteristic voltage for the gap distance L.

As depicted by a sub-region 104 (which is intended to be representative of the VSD material 100), VSD material 100 comprises particle constituents that individually carry charge when voltage or field acts on the VSD composition. If the field/voltage is above the trigger threshold, sufficient charge is carried by at least some types of particles to switch at least a portion of the composition 100 into a conductive state. More specifically, as shown for representative sub-region 104, individual particles (of types such as conductor particles, core shell particles or other semiconductive or compound particles) acquire conduction regions 122 in the polymer binder 105 when a voltage or field is present. The voltage or field level at which the conduction regions 122 are sufficient in magnitude and quantity to result in current passing through a thickness of the VSD material 100 (e.g. between boundaries 102) coincides with the characteristic trigger voltage of the composition. The presence of conductive particles is believed to amplify the external voltage 108 within the thickness of the composition, so that the electric field of the individual conduction regions 122 is more than an order of magnitude greater than the field of the applied voltage 108.

FIG. 1 illustrates presence of conduction regions 122 in a portion of the overall thickness. The portion or thickness of the VSD material 100 provided between the boundaries 102 is representative of the separation between lateral or vertically displaced electrodes. When voltage is present, some or all of the portion of VSD material is affected to increase the magnitude or count of the conduction regions in that region. When voltage is applied, the presence of conduction regions varies across the thickness (either vertical or lateral thickness) of the VSD composition, depending on, for example, the location and magnitude of the voltage of the event. For example, only a portion of the VSD material may pulse, depending on voltage and power levels of the electrical event.

Accordingly, FIG. 1 illustrates that the electrical characteristics of the VSD composition, such as conductivity or trigger voltage, is affected in part by (i) the concentration of particles, such as conductive particles, semiconductive particles, or other particles (e.g. core shell particles); (ii) electrical and physical characteristics of the particles, including resistive characteristics (which are affected by the type of particles, such as whether the particles are core shelled or conductors); and (iii) electrical characteristics of the binder 105 (including electron mobility of the polymer material used for the binder).

Specific compositions and techniques by which organic and/or HAR particles are incorporated into the composition of VSD material is described in U.S. patent application Ser. No. 11/829,946, entitled VOLTAGE SWITCHABLE DIELECTRIC MATERIAL HAVING CONDUCTIVE OR SEMI-CONDUCTIVE ORGANIC MATERIAL; and U.S. patent application Ser. No. 11/829,948, entitled VOLTAGE SWITCHABLE DIELECTRIC MATERIAL HAVING HIGH ASPECT RATIO PARTICLES; both of the aforementioned patent applications are incorporated by reference in their respective entirety by this application.

Additionally, an embodiment provides for VSD material that includes varistor particles as a portion of its particle constituents. Thus, an embodiment incorporates a concentration of particles that individually exhibit non-linear resistive properties, so as to be considered active varistor particles. Such particles typically comprise zinc oxide, titanium dioxide, Bismuth oxide, Indium oxide, in oxide, nickel oxide, copper oxide, silver oxide, praseodymium oxide, Tungsten oxide, and/or antimony oxide. Such a concentration of varistor particles may be formed from sintering the varistor particles (e.g. zinc oxide) and then mixing the sintered particles into the VSD composition. In some applications, the varistor particle compounds are formed from a combination of major components and minor components, where the major components are zinc oxide or titanium dioxide, and the minor components or other metal oxides (such as listed above) that melt of diffuse to the grain boundary of the major component through a process such as sintering.

Particles with high bandgap (e.g. using insulative shell layer(s)) can also be used. Accordingly, in some embodiments, the total particle concentration of the VSD material, with the inclusion of a concentration of core shell particles (such as described herein), is sufficient in quantity so that the particle concentration exceeds the percolation threshold of the composition.

Under some conventional approaches, the composition of VSD material has included metal or conductive particles that are dispersed in the binder of the VSD material. The metal particles range in size and quantity, depending in some cases on desired electrical characteristics for the VSD material. In particular, metal particles may be selected to have characteristics that affect a particular electrical characteristic. For example, to obtain lower clamp value (e.g. an amount of applied voltage required to enable VSD material to be conductive), the composition of VSD material may include a relatively higher volume fraction of metal particles. As a result, it becomes difficult to maintain a low initial leakage current (or high resistance) at low biases due to the formation of conductive paths (shorting) by the metal particles. As described below, the polymer material may be selected and/or doped to facilitate reduction in clamp/trigger voltage with minimal negative impact to desired off-state electrical characteristics of the VSD material.

Polymer Binder with Enhanced High Field Electron Mobility

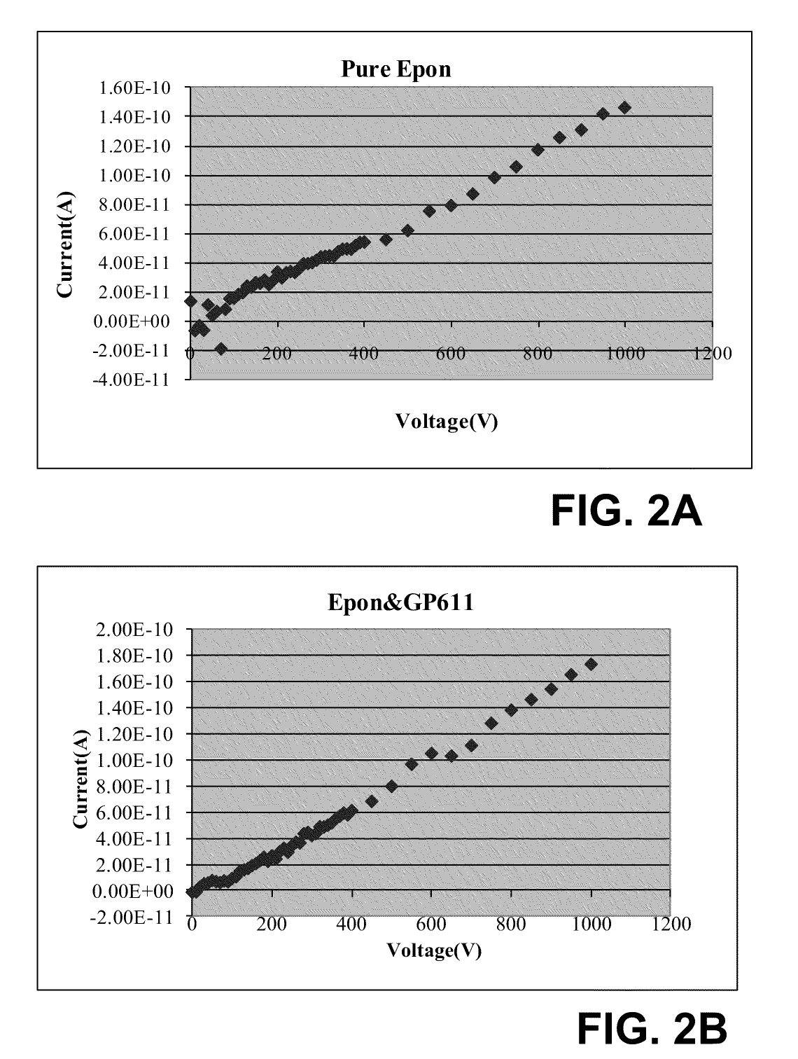

FIG. 2A through FIG. 4 graphically display experimental results in which conductivity versus electric field for various polymer resins have been measured. The measurements were made for a 2.5 mil gap with 45 mil inner pad diameters. The measurements have been used to identify polymers that exhibit high field electron mobility (e.g. HFC polymers).

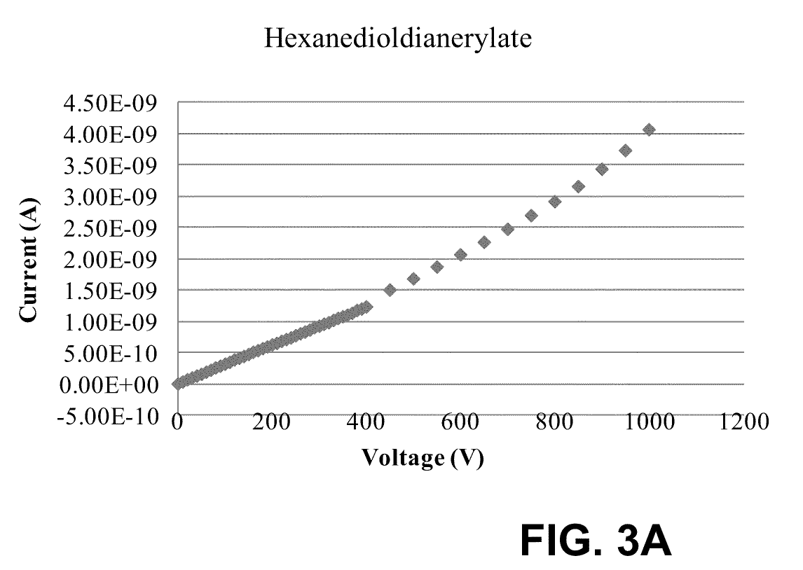

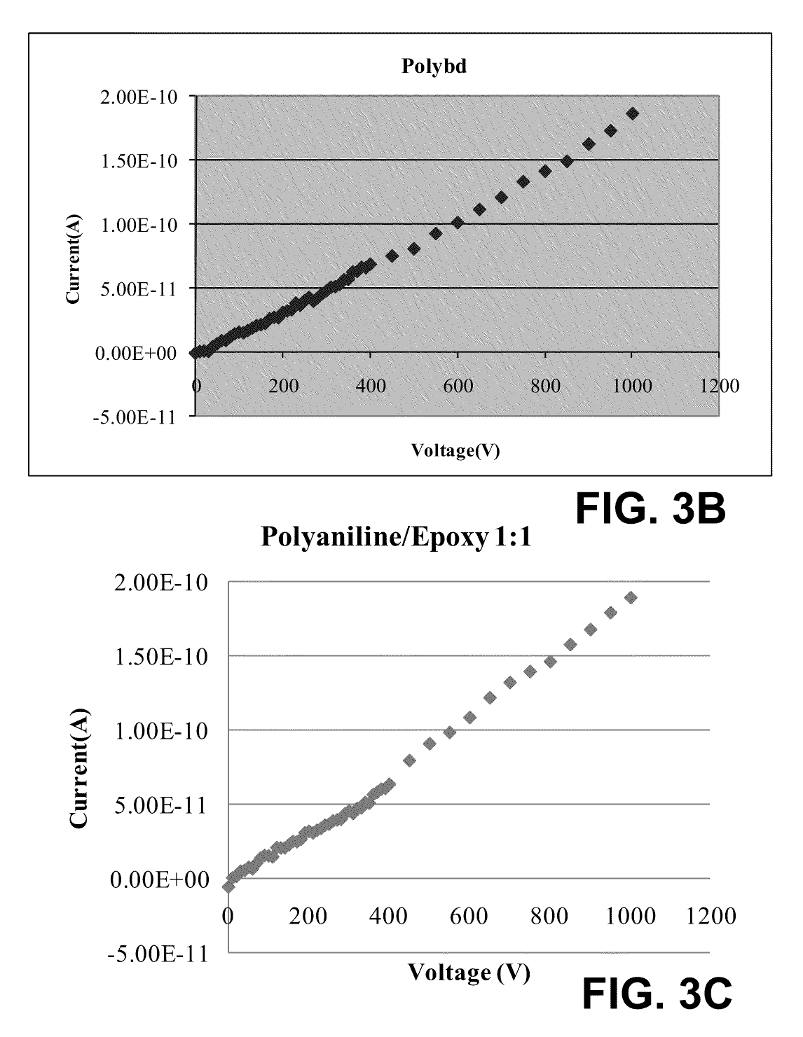

With reference to the figures, FIG. 2A and FIG. 2B depict conductivity versus electric field for a standard epoxy (Epon828) based polymer binders, including pure Epon (FIG. 2A) and the mixture of Epon and an epoxidized silicone resin (GP611). In considering the high field electron mobility of the binder, a VSD material designer may be motivated to select the mixture of Epon and GP611) in combination with HFC materials as in FIG. 3A. Thus, FIG. 2B illustrates an improved polymer binder for VSD material, when considering the parameter of electron mobility.

In contrast to FIG. 2A and FIG. 2B, FIG. 3A illustrates the conductivity versus electric field measurements for a HFC polymer. In the example shown, the HFC polymer is a polyacrylate type, and more specifically, Hexanedioldiacrylate (HDDA). As depicted by FIG. 3A, the high field conductivity of the HFC polymer is greater than that of pure Epon, in that HDDA is able to carry current that is measured in the range of approximately 1.5E-09 (at about 400 volts) to 4.0E-09 amps (at about 1000 volts). In contrast, pure Epon carries 5.0E-11 (at about 400 volts) to 1.5E-10 amps (at about 1000 volts).

FIG. 3B and FIG. 3C depict conductivity versus electric field measurements for suitable alternative polymer materials that exhibit improved electron mobility at high electric fields. Surprisingly, in FIG. 3C, Polyaninlne/Epoxy 1:1, is shown to carry current of about 1.8 to 2.0E-10 at 1000 volts, which is much less current than that of HFC polymers such as HDDA Embodiments described herein anticipate that polymers with carbonyl groups, such as hexanedioldiacrylate, have improve high field conductivity.

With regard to the conductivity versus electric field measurements depicted for various polymer materials, it should be noted that in a VSD application, the actual amount of electric field that is present is significantly higher than that provided from an externally applied voltage. As previously mentioned, conductive particles within the VSD composition amplify the externally applied electric field. For example, an electrical event measuring in the neighborhood of 1000 volts may generate an internal electric field within the material that is in the range of tens of thousands of volts.

FIG. 4 illustrates conductivity versus electric field measurements for a polymer-based matrix that includes various fillers. The examples provided use the following nano-dimensioned particles: carbon-nanotubes (CNT), Antimony in oxide (ATO), zinc-oxide (ZnO) and Bismuth Oxide (Bi₂O₃). In each example, the particles are thoroughly mixed into the polymer resin (e.g. Epon&GP611) in advance of receiving metal particles or other particles and compounds that result in the compound having its switchable electrical characteristic. Results show that the polymer-based matrix has improved electron mobility at high electric fields. The polymer matrix with ATO and CNT shows higher conductivity in contrast to the pure polymer resin and polymer matrix with other semiconductor filler. It is anticipated that the polymer matrix with larger conductivity under high electric field results in reducing the clamp and trigger voltages of the resulting VSD material.

Table 1 lists experimental values for VSD composite that includes various types of polymer binders. Each of the VSD composites listed in Table 1 includes the same general concentrations of conductive and semi-conductive particles (see Table 2 for precise concentrations). The primary variance between each composition is that the polymer-based binder is changed. All depicted voltages are across a 2.5 mil gap.

| | Gap-PAD | | | |
|---|---|---|---|---|
| | Dia | | | 10 ns Clamp |
| Polymer | (mil) | Trigger (V) | Clamp (V) | (V) |
| Epon | 2.5-25 | 450 | 213 | 252 |
| &GP611(3:1) | | | | |
| Standard VSDM | | | | |
| HDDA & PolyBD | 2.5-20 | 326 | 110 | 108 |
| HDDA& PolyBD& | 2.5-25 | 359 | 152 | 189 |
| GP611(1:1:0.5) | | | | |
| HDDA with | 2.5-25 | 366 | 149 | 188 |
| Epon(1:1) | | | | |

Table 1 shows that the electrical properties of the VSD material changes when different polymer based binders are used. Table 1 illustrates that the VSD compositions generally exhibit lower clamp and trigger voltages in relation to the polymer-based binder having increased electron mobility under high field. The VSD compositions that include the HFC polymer Hexanedioldiacrylate (HDDA) in its binder, such as (i) HDDA with polyBD, (ii) HDDA with EPON, or (iii) HDDA with both polyBD and GP611 show a trigger value of 80-100V (2.5 mil gap) lower than when standard binder systems (EPON &GP611) are used in polymer composites. Hexanedioldiacrylate (HDDA) when combined with other resins and used as a binder for polymer composites also switches faster than the standard binder system for VSD material.

According to one or more embodiments, VSD composition that incorporates HFC polymers (e.g. HDDA) may comprise of 25% metal particle fillers, 25% semiconductor fillers (micron sized or nano sized), optionally may include 1% nanoparticles (e.g. nanorods, nanowires or carbon nanotubes). Broader ranges of the particles may also be used. For example, VSD material may comprise of 10-40% metal particle filler, 10-45% semiconductor particles, and 0.1-15% nanoparticles. In such embodiments, the polymer matrix may correspond to a mixture of hexanedioldiacrylate and epoxy. The measured electrical properties of the sample, such as trigger voltage and clamp voltage are roughly 100-200V lower than the sample materials with pure epoxy as polymer resin. More specific compositions are also provided with Table 2.

The following lists one process for formulating a VSD composition using HDDA polymer mixture (see row 4 of Table 1). In a clean plastic 1000 ml beaker, 4.74 g of shorts graphitized (d>50 nm, l=0.2-1 um) carbon nanotubes (CNTs, manufactured by CHEAP TUBES INC.) are mixed with 65.9 g of epoxy (EPON 828) and 65.9 g of HDDA, added in liquid resin form. Next, 160 g of N-methyl-2-pyrrolidone (is added as the solvent to the above mixture. Then 20.1 g of dicyandiamide and 0.75 g of 1-Methyl imidazole are added as the curing agent and catalyst. The beaker is placed in a cold water bath to control the temperature during premixing. The mixture was mixed to make the solution a uniform mixture of CNTs, resin and solvent. The mixing was further remixed. Then 70.5 g of P25 (TiO₂) is weighed out and 2.37 g of KR44 (isopropyl tri (N-ethylenediamino) ethyl titanate) is added to the powder to disperse the particles. The P25 powder is slowly added to the beaker mixture while mixing with the blade simultaneously. Additionally fillers are added: 564.4 g of wet-chemistry processed oxidized Ni, 76.4 g of TiO₂, and 127.5 g of bismuth oxide (Bi₂O₃) are weighed out and then added slowly to the mixture containing the CNTs and the resin. Then 0.66 g of benzoyl peroxide is dissolved in 5 g of NMP and then added to the mixture, so as to initiate the free radical polymerization of HDDA. Next, the mixture was remixed.

Table 2 lists the compositions of each of the VSD compositions identified in Table 1, in greater detail.

| | | | | | | DT52 | P25 |
|---|---|---|---|---|---|---|---|
| | | epon828 | | polyBD | HDDA | TiO2 | TiO2 |
| Resin system | CNT (g) | (g) | GP611 (g) | (g) | (g) | (g) | (g) |
| epon:GP611 (3:1)- | 2.22 | 89.3 | 29.8 | 0 | 0 | 70 | 64.6 |
| std | | | | | | | |
| polyBD:HDDA:GP611 | 4.61 | 0 | 26.95 | 53.9 | 53.9 | 78.5 | 72.4 |
| (1:1:0.5) | | | | | | | |
| HDDA:polyBD (1:1) | 4.6 | 0 | 0 | 65.9 | 65.9 | 80 | 73.8 |
| HDDA:epon828 (1:1) | 4.74 | 65.9 | 0 | 0 | 65.9 | 76.4 | 70.5 |

| | | | catalyst (1- | | benzoyl | | |
|---|---|---|---|---|---|---|---|
| | | | methylimidazole) | dicy in | peroxide | | |
| Resin system | Bi₂O₃ (g) | Ni 4SP-10 (g) | (g) | NMP (g) | (g) | KR44 (g) | NMP (g) |
| epon:GP611 (3:1)- | 119.8 | 475.4 | 0.63 | 37.3 | 0 | 1.98 | 150 |
| std | | | | | | | |
| polyBD:HDDA:GP611 | 130.5 | 591 | 0.76 | 29.2 | 0.54 | 2.45 | 110 |
| (1:1:0.5) | | | | | | | |
| HDDA:polyBD (1:1) | 134 | 590 | 0.76 | 19 | 0.66 | 2.45 | 130 |
| HDDA:epon828 (1:1) | 127.5 | 564.4 | 0.75 | 20.1 | 0.66 | 2.37 | 160 |

While some variations exist amongst the listed VSD compositions in terms of the concentration of particle constituents, the difference in electrical characteristics of the various compositions (see clamp and trigger voltage values listed in Table 1) is significantly the result of the variation in the polymer constituent(s) of each compositions binder.

VSD Material Applications

Numerous applications exist for compositions of VSD material in accordance with any of the embodiments described herein. In particular, embodiments provide for VSD material to be provided on substrate devices, such as printed circuit boards, semiconductor packages, discrete devices, thin film electronics, as well as more specific applications such as LEDs and radio-frequency devices (e.g. RFID tags). Still further, other applications may provide for use of VSD material such as described herein with a liquid crystal display, organic light emissive display, electrochromic display, electrophoretic display, or back plane driver for such devices. The purpose for including the VSD material may be to enhance handling of transient and overvoltage conditions, such as may arise with ESD events. Another application for VSD material includes metal deposition, as described in U.S. Pat. No. 6,797,125 to L. Kosowsky (which is hereby incorporated by reference in its entirety).

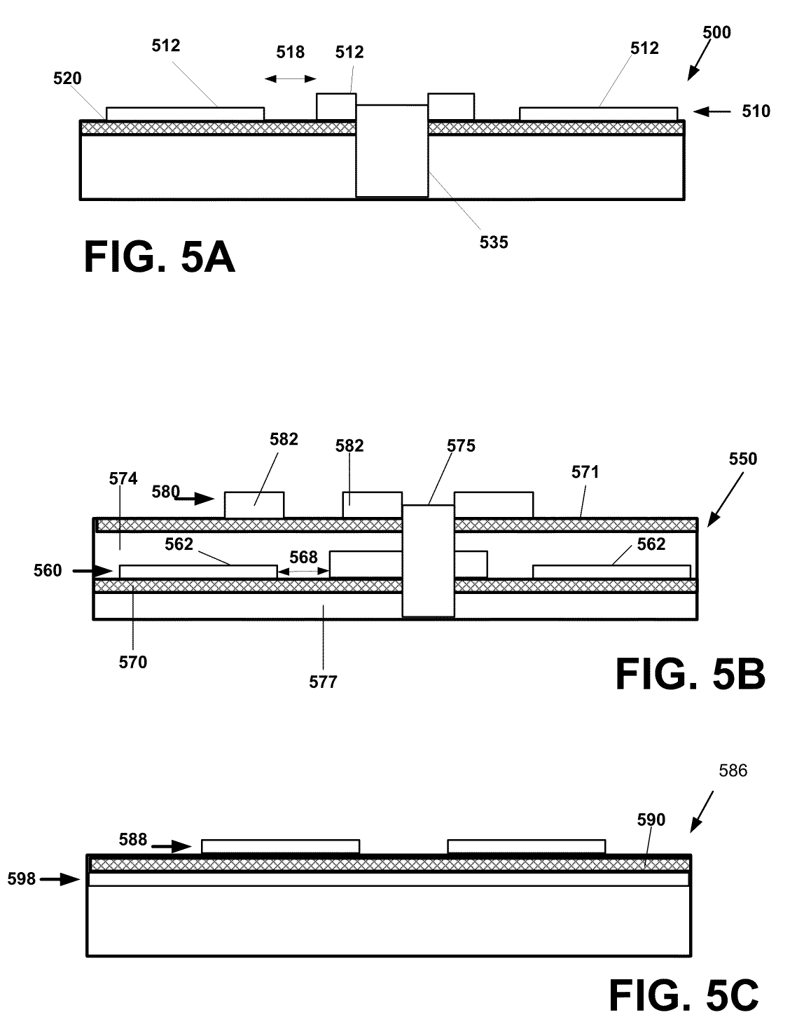

FIG. 5A illustrates a substrate device that is configured with VSD material having a composition such as described with any of the embodiments provided herein. As shown by FIG. 5A, the substrate device 500 corresponds to, for example, a printed circuit board. A conductive layer 510 comprising electrodes 512 and other trace elements or interconnects is formed on a thickness of surface of the substrate 500. In a configuration as shown, VSD material 520 (having a composition such as described with any of the embodiments described herein) may be provided on substrate 500 (e.g. as part of a core layer structure) in order provide, in presence of a suitable electrical event (e.g. ESD), a lateral switch between electrodes 512 that overlay the VSD layer 520. The gap 518 between the electrode 512 acts as a lateral or horizontal switch that is triggered ‘on’ when a sufficient transient electrical event takes place. In one application, one of the electrodes 512 is a ground element that extends to a ground plane or device. The grounding electrode 512 interconnects other conductive elements 512 that are separated by gap 518 to ground as a result of material in the VSD layer 520 being switched into the conductive state (as a result of the transient electrical event).

In one implementation, a via 535 extends from the grounding electrode 512 into the thickness of the substrate 500. The via provides electrical connectivity to complete the ground path that extends from the grounding electrode 512. The portion of the VSD layer that underlies the gap 518 bridges the conductive elements 512, so that the transient electrical event is grounded, thus protecting components and devices that are interconnected to conductive elements 512 that comprise the conductive layer 510.

FIG. 5B illustrates a configuration in which a conductive layer is embedded in a substrate. In a configuration shown, a conductive layer 560 comprising electrodes 562, 562 is distributed within a thickness of a substrate 550. A layer of VSD material 570 and dielectric material 574 (e.g. B-stage material) may overlay the embedded conductive layer. Additional layers of dielectric material 577 may also be included, such as directly underneath or in contact with the VSD layer 570. Surface electrodes 582, 582 comprise a conductive layer 580 provided on a surface of the substrate 550. The surface electrodes 582, 582 may also overlay a layer VSD material 571. One or more vias 575 may electrically interconnect electrodes/conductive elements of conductive layers 560, 580. The layers of VSD material 570, 571 are positioned so as to horizontally switch and bridge adjacent electrodes across a gap 568 of respective conductive layers 560, 580 when transient electrical events of sufficient magnitude reach the VSD material.

As an alternative or variation, FIG. 5C illustrates a vertical switching arrangement for incorporating VSD material into a substrate. A substrate 586 incorporates a layer of VSD material 590 that separates two layers of conductive material 588, 598. In one implementation, one of the conductive layers 598 is embedded. When a transient electrical event reaches the layer of VSD material 590, it switches conductive and bridges the conductive layers 588, 598. The vertical switching configuration may also be used to interconnect conductive elements to ground. For example, the embedded conductive layer 598 may provide a grounding plane.

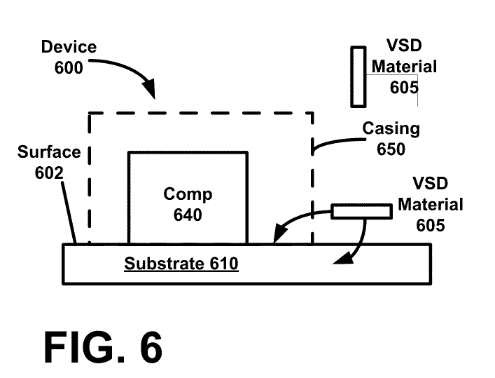

FIG. 6 is a simplified diagram of an electronic device on which VSD material in accordance with embodiments described herein may be provided. FIG. 6 illustrates a device 600 including substrate 610, component 640, and optionally casing or housing 650. VSD material 605 (in accordance with any of the embodiments described) may be incorporated into any one or more of many locations, including at a location on a surface 602, underneath the surface 602 (such as under its trace elements or under component 640), or within a thickness of substrate 610. Alternatively, the VSD material may be incorporated into the casing 650. In each case, the VSD material 605 may be incorporated so as to couple with conductive elements, such as trace leads, when voltage exceeding the characteristic voltage is present. Thus, the VSD material 605 is a conductive element in the presence of a specific voltage condition.

With respect to any of the applications described herein, device 600 may be a display device. For example, component 640 may correspond to an LED that illuminates from the substrate 610. The positioning and configuration of the VSD material 605 on substrate 610 may be selective to accommodate the electrical leads, terminals (i.e. input or outputs) and other conductive elements that are provided with, used by or incorporated into the light-emitting device. As an alternative, the VSD material may be incorporated between the positive and negative leads of the LED device, apart from a substrate. Still further, one or more embodiments provide for use of organic LEDs, in which case VSD material may be provided, for example, underneath an organic light-emitting diode (OLED).

With regard to LEDs and other light emitting devices, any of the embodiments described in U.S. patent application Ser. No. 11/562,289 (which is incorporated by reference herein) may be implemented with VSD material such as described with other embodiments of this application.

Alternatively, the device 600 may correspond to a wireless communication device, such as a radio-frequency identification device. With regard to wireless communication devices such as radio-frequency identification devices (RFID) and wireless communication components, VSD material may protect the component 640 from, for example, overcharge or ESD events. In such cases, component 640 may correspond to a chip or wireless communication component of the device. Alternatively, the use of VSD material 605 may protect other components from charge that may be caused by the component 640. For example, component 640 may correspond to a battery, and the VSD material 605 may be provided as a trace element on a surface of the substrate 610 to protect against voltage conditions that arise from a battery event. Any composition of VSD material in accordance with embodiments described herein may be implemented for use as VSD material for device and device configurations described in U.S. patent application Ser. No. 11/562,222 (incorporated by reference herein), which describes numerous implementations of wireless communication devices which incorporate VSD material.

As an alternative or variation, the component 640 may correspond to, for example, a discrete semiconductor device. The VSD material 605 may be integrated with the component, or positioned to electrically couple to the component in the presence of a voltage that switches the material on.

Still further, device 600 may correspond to a packaged device, or alternatively, a semiconductor package for receiving a substrate component. VSD material 605 may be combined with the casing 650 prior to substrate 610 or component 640 being included in the device.

Although illustrative embodiments have been described in detail herein with reference to the accompanying drawings, variations to specific embodiments and details are encompassed herein. It is intended that the scope of the invention is defined by the following claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A composition of voltage switchable dielectric (VSD) material comprising:
a binder comprising a polymer material that has a characteristic of being capable of carrying at least 1.0 E-9 amps in presence of a electric field that is equivalent to 400 volts per mil; and
one or more types of particles dispersed in the binder;
wherein the particles and the binder form the composition to be non-conductive in absence of an electric field that exceeds a threshold value, and conductive in presence of the electric field that exceeds the threshold value.

2. The composition of claim 1, wherein the binder has the characteristic of being capable of carrying at least 2.0 E-09 amps in presence of electric field that is equivalent to 400 volts per mil.

3. The composition of claim 2, wherein the binder comprises polyacrylate.

4. The composition of claim 3, wherein the binder comprises Hexanedioldiacrylate.

5. The composition of claim 1, wherein the binder comprises one or more binders selected from (i) Polyaninlne, (ii) Polybd, or (iii) Hexanedioldiacrylate.

6. The composition of claim 5, wherein the binder further comprises epoxy.

7. The composition of claim 1, wherein a collective concentration level of the particles dispersed in the binder is below a percolation threshold of the binder.

8. The composition of claim 1, wherein the one or more types of particles include a concentration of metal particles.

9. The composition of claim 1, wherein the one or more types of particles include a concentration of semiconductive fillers that are dispersed in the binder in advance of the concentration of metal particles.

10. The composition of claim 1, wherein the concentration of semiconductive fillers include carbon nanotubes.

11. The composition of claim 1, wherein the concentration of semiconductive fillers include antimony in oxide (ATO).

12. The composition of claim 1, wherein the concentration of semiconductive fillers include zinc oxide.

13. A binder for use in a VSD composition, the binder comprising:
polymer material;
one or more concentrations of nano-dimensioned semiconductive particles, the one or more concentrations of particles being mixed with the polymer material in advance of conductive particles and other particle constituents that are to comprise the VSD composition;
wherein the binder is formulated to conduct at least 1.0 E-09 amps in presence of an electric field that is equivalent to 400 volts per mil.

14. The binder of claim 13, wherein the one or more concentrations of nano-dimensioned semi-conductive particles include carbon nanotubes.

15. The binder of claim 13, wherein the one or more concentrations of nano-dimensioned semi-conductive particles include antimony in oxide (ATO).

16. The binder of claim 13, wherein the one or more concentrations of nano-dimensioned semi-conductive particles include antimony in oxide (ATO) and carbon nanotubes.

17. The binder of claim 13, wherein the polymer material includes Hexanedioldiacrylate.

18. The binder of claim 13, wherein the binder is formulated to conduct at least 1.0 E-06 amps in presence of an electric field that is equivalent to 1000 volts per mil.

19. The binder of claim 13, wherein the one or more concentrations of nano-dimensioned semi-conductive particles include zinc oxide.

20. The binder of claim 13, wherein the one or more concentrations of nano-dimensioned semi-conductive particles include Bismuth Oxide (Bi₂O₃).
